(19) United States
(12) Patent Application Publication
(10) Pub. No.: US 2014/0040760 A1
(43) Pub. Date: Feb. 6, 2014

(54) PERSONALIZED ENTERTAINMENT SERVICES CONTENT SYSTEM

(71) Applicants: Jason Randell, Oakland, CA (US); Erik Johnson, Dublin, CA (US); Eric Anderson, Richmond, CA (US)

(72) Inventors: Jason Randell, Oakland, CA (US); Erik Johnson, Dublin, CA (US); Eric Anderson, Richmond, CA (US)

(73) Assignee: CBS INTERACTIVE, INC., San Francisco, CA (US)

(21) Appl. No.: 13/601,484

(22) Filed: Aug. 31, 2012

Related U.S. Application Data
(60) Provisional application No. 61/677,852, filed on Jul. 31, 2012.

(51) Int. Cl. G06F 3/01; G06F 17/30

(52) U.S. Cl. 715/745; 463/43

(57) ABSTRACT

An entertainment content personalization system is described. A method may comprise accessing content for presentation on a user interface, the content comprising entertainment services content associated with content data; generating user data comprising user profile data and user interaction data, the user interaction data based on interactions with the content through the user interface; and presenting personalized content on the user interface comprising content selected based on the user data and the content data. Other embodiments are described and claimed.

### RELATED APPLICATION

This application claims the benefit of, and priority to, commonly owned and co-pending U.S. Provisional Patent Application Ser. No. 61/677,852 entitled “PERSONALIZED ENTERTAINMENT SERVICES CONTENT SYSTEM” filed on Jul. 31, 2012, the subject matter of which is hereby incorporated by reference in its entirety.

### BACKGROUND

Consumer interaction with entertainment content has been dramatically transformed as a result of technological advances in both content delivery and consumer electronic device technology. As a result, the general public is no longer limited to interfacing with content such as television shows, movies, video games, and music solely through one medium. For instance, users may now access original entertainment content through a wide range of computing devices, such as laptop computers, smart phones, and tablet computing devices. In addition, content producers commonly develop a suite of secondary experiences based on original content, such as games, videos, applications, and discussion forums. As such, users may now have nearly instantaneous access to a vast number of content offerings via multiple computing devices.

However, the escalating amount of content offerings may also present difficulties in that users must sift through ever-increasing amounts of irrelevant content to locate actual content of interest. This effect may overwhelm users and actually lead to decreased content consumption and return visits to content developer websites. Therefore, one design goal for content providers is to develop content platforms capable of automatically and dynamically delivering personalized entertainment content to users. As such, techniques designed to personalize entertainment content presentation and offerings are desirable.

### BRIEF DESCRIPTION OF THE DRAWINGS

FIG. 1 illustrates an embodiment of an entertainment content personalization system.

FIG. 2 illustrates an embodiment of a first operating environment for a content personalization application.

FIG. 3 illustrates an embodiment of a second operating environment for a content personalization application.

FIG. 4 illustrates an embodiment of a third operating environment for a content personalization application.

FIG. 5 illustrates an embodiment of a fourth operating environment for a content personalization application.

FIG. 6 illustrates a logic flow in accordance with one or more embodiments.

FIG. 7 illustrates a second logic flow in accordance with one or more embodiments.

FIG. 8 illustrates a computing architecture in accordance with one or more embodiments.

FIG. 9 illustrates an embodiment of a communications architecture.

### DETAILED DESCRIPTION

Entertainment content providers, such as media broadcasters (e.g., CBS Corporation), increasingly provide users with alternative access to content beyond conventional channels, such as broadcast television. For example, a television program may now have an associated website or web pages within a media broadcaster website. From this program website, a visitor may access the original television program as well as secondary content, such as games, additional information, and video related to the original content. These websites have proven to be extremely popular, especially for individuals highly interested in a particular content offering. In order to keep visitor interest and to encourage return website visits, content providers may benefit from a system that presents content tailored to each visitor's interests. In addition, content providers may leverage user interest in a particular content offering to attract users to other programs. It is with respect to these and other considerations that the present improvements have been needed to increase content consumption, build product loyalty, increase online advertising revenue, and attract new content consumers.

Various embodiments are directed to techniques for presenting personalized entertainment content at a user interface to users based on information associated with the users. In one embodiment, users may register with the user interface or an entity serving the website and create a user profile. The embodiments may automatically and dynamically update user information based on certain events, including, without limitation, user interaction with the entertainment content, user specified profile information, or external data sources. The user interface may comprise a website presenting entertainment content, such as video, games, discussion forums, contests, and combinations thereof. Users may be presented with entertainment content based on associated profile information elements, including user specified elements (e.g., favorite entertainment content offerings, categories, etc.), elements determined based on user interaction with the content, and recommendation elements. For instance, a profile information element may indicate that a user prefers content related to a particular television program. A recommendation engine may operate to present recommended content to the user based on user access patterns within the user interface directed toward the particular television program. In this manner, when a user having profile information visits a user interface configured according to embodiments, the user may be presented with recommended content personalized based on associated profile information.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

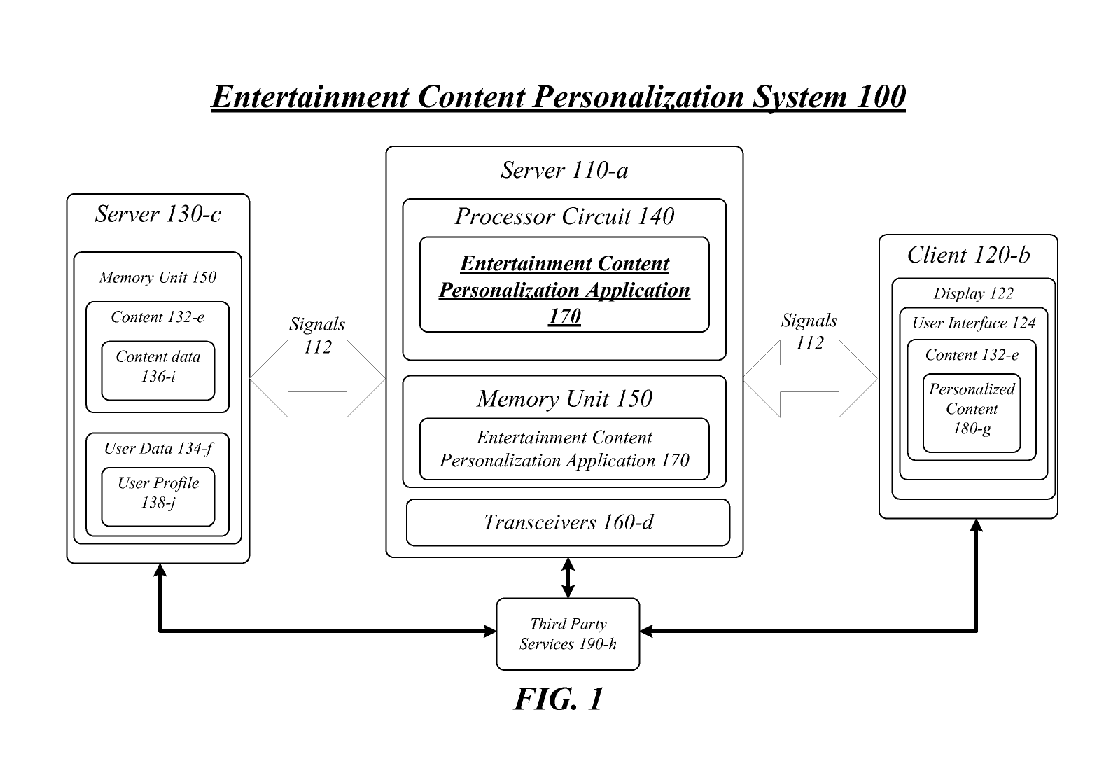

FIG. 1 illustrates a block diagram for an entertainment content personalization system 100. In one embodiment, the entertainment content personalization system 100 may comprise a computer-based system comprising a server 110-a. The server 110-a may comprise, for example, a processor circuit 140, a memory unit 150, and one or more transceivers 160-d. The server 110-a may further comprise an entertainment content personalization application 170. The memory unit 150 may store an unexecuted version of the entertainment content personalization application 170. Although the entertainment content personalization system 100 shown in FIG. 1 has a limited number of elements in a certain topology, it may be appreciated that the entertainment content personalization system 100 may include more or less elements in alternate topologies as desired for a given implementation.

It is worthy to note that “a,” “b,” “c” and similar designators as used herein are intended to be variables representing any positive integer. Thus, for example, if an implementation sets a value for a=5, then a complete set of servers 110-a may include servers 110-1, 110-2, 110-3, 110-4, and 110-5. The embodiments are not limited in this context.

In various embodiments, the entertainment content personalization system 100 may comprise multiple computing devices, such as servers 110-a, 130-c and clients 120-b. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, servers 110-a and 130-c may be implemented as a web server and a network server, respectively, accessible over a network, such as the Internet. The client 120-b may be implemented as a desktop computer or a mobile device having a portable power supply and wireless communications capabilities, such as a laptop computer, handheld computer, tablet computer, smart phone, gaming device, consumer electronic, or other mobile device. The embodiments are not limited to these examples, however, and any servers 110-a, 130-c and clients 120-b may be used as desired for a given implementation. The servers 110-a may communicate with other computing devices 130-c, 120-b using communications signals 112 via the transceivers 160-d. The embodiments are not limited in this context.

In various embodiments, the entertainment content personalization system 100 may comprise a processor circuit 140. The processor circuit 140 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 140.

In various embodiments, the entertainment content personalization system 100 may comprise a memory unit 150. The memory unit 150 may store, among other types of information, the entertainment content personalization application 170. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Content 132-e may comprise any defined set of electronic information, data, or content capable of being uniquely identified, presented by a user interface 124, or represented by a user interface element of a user interface 124. One example of a user interface 124 may comprise a graphical user interface (GUI). According to certain embodiments, content 132-e may be associated with content data 136-i, for example, comprising data describing one or more features of the content 132-e. One exemplary class of content 132-e may include, without limitation, software computer files, including application files (e.g., document files, word processing files, spreadsheet files, presentation files, etc.), system files (e.g., operating system files, library files, utility files, etc.), and multimedia content files (e.g., audio files, video files, audio/video files, picture files, image files, etc.). Other examples of content 132-e may include without limitation objects presented by a user interface 124, user interface elements, GUI elements, multimedia content (e.g., pictures, images, video, audio, graphics, games, discussion forums, blogs, contests, etc.), software programs, views of software programs, application documents, application content (e.g., a paragraph from a word processing document or work sheet from a spreadsheet document), a web page, a web site, a uniform resource locator (URL) from a web browser, clipboard data, screenshots, device resource data (e.g., sensor data), and so forth. These are merely a few examples, and any type of defined set of electronic information, data, or content may comprise content 132-e as utilized in the entertainment content personalization system 100. As illustrated in FIG. 1, the content 132-e may be located on servers 110-a or on a computing device accessible by the servers 110-a, such as one or more of servers 130-c, through the transceivers 160-d. The embodiments are not limited in this context.

Users may access content 132-e through a user interface 124 accessible by a display 122 of a client 120-b. The display 122 may comprise any digital display device suitable for the one or more clients 120-b. For instance, the display 122 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content 132-e on a user interface 124 to a user of the one or more clients 120-b.

In various embodiments, the servers 110-a may comprise one or more transceivers 160-d. Each of the transceivers 160-d may be implemented as wired transceivers, wireless transceivers, or a combination of both. In some embodiments, the transceivers 160-d may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 160-d may comprise or implement various communication techniques to allow the servers 110-a to communicate with other electronic devices, such as the servers 130-c and the clients 120-b. For instance, the wireless transceivers 160-d may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the servers 110-a may implement different types of transceivers 160-d. Each of the transceivers 160-d may implement or utilize a same or different set of communication parameters to communicate information between various electronic devices. In one embodiment, for example, each of the transceivers 160-d may implement or utilize a different set of communication parameters to communicate information between the servers 110-a and one or more remote devices, such as remote servers 130-c and remote clients 120-b. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 160-d. The embodiments are not limited in this context.

In one embodiment, for example, the transceiver 160-d may comprise a radio designed to communicate information over a wireless local area network (WLAN), a wireless metropolitan area network (WMAN), a wireless wide area network (WWAN), or a cellular radiotelephone system. The transceiver 160-d may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 160-d may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

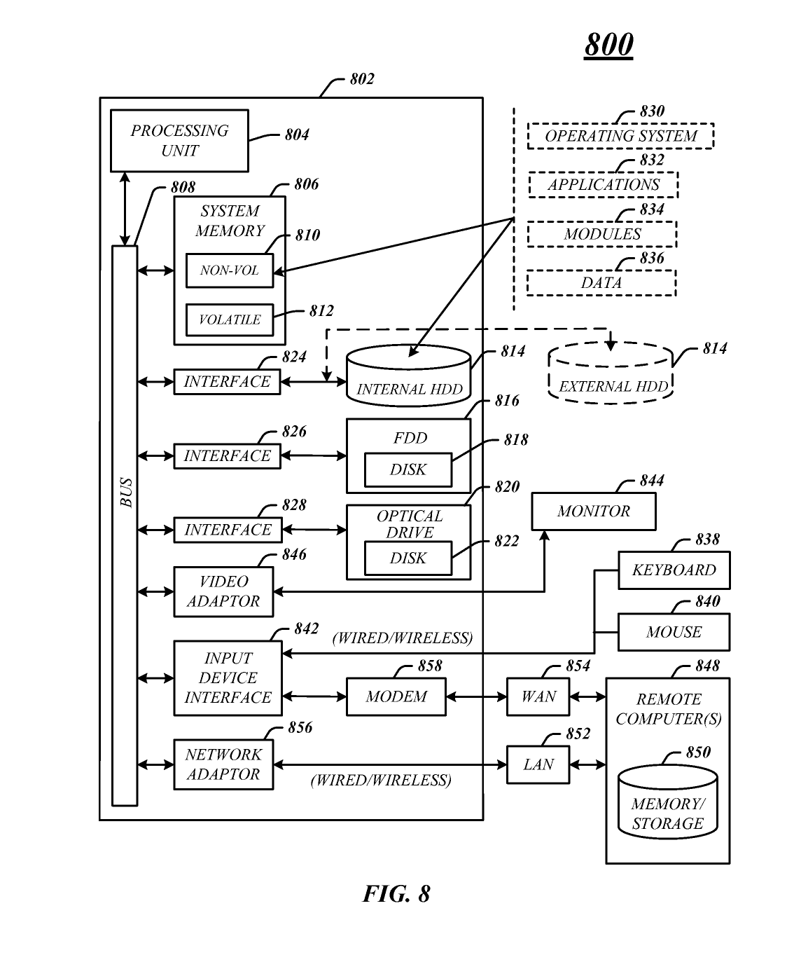

Although not shown, the servers 110-a, 130-c, and clients 120-b may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 8. The embodiments, however, are not limited to these examples.

In the illustrated embodiment shown in FIG. 1, the processor circuit 140 may be communicatively coupled to the transceiver 160-d and the memory unit 150. The memory unit 150 may store an entertainment content personalization application 170 arranged for execution by the processor circuit 140 to present content 132-e to one or more clients 120-b through a user interface 124 via the transceivers 160-d. The servers 130-c and clients 120-b may implement similar elements as the servers 110-a, including a processor circuit 140, a memory unit 150, and transceivers 160-d. For example, servers 130-c may be comprised of a memory unit 150 storing content 132-e comprising content data 136-i. The user profiles 138-j may be stored on servers 130-c, on clients 120-b, or some combination thereof. The entertainment content personalization application 170 may access the user profiles 138-j of users accessing content 132-e at the user interface 124 through communication signals 112 received at the transceivers 160-d.

Servers 130-c may be comprised of a memory unit 150 storing content 132-e comprised of content data 136-i, and user data 134-f that may be comprised of one or more user profiles 138-j. In one embodiment, the content data 136-i may comprise data associated with one or more particular instances of content 132-e. For example, the content data 136-i, may comprise, without limitation, name, date, genre, category, popularity ranking, quality rating, description, related content, recommended content, keywords, and content family information.

Certain embodiments provide that the user data 134-f may comprise information associated with one or more entertainment content personalization system 100 users. For example, each entertainment content personalization system 100 user may register with the system and create a user profile 138-j. The user profile 138-j may comprise information about the user including, but not limited to, name, demographic and location information, entertainment content preferences, and any other information relevant to personalizing content 132-e. In addition, the entertainment content personalization application 170 may operate to monitor user activity within the entertainment content personalization system 100. For example, user interaction (e.g., browsing patterns, content 132-e access, etc.) with content 132-e may be monitored and stored as user data 134-f, such as user interaction data. In one embodiment, the user interaction data may be stored as user data 134-f and additionally associated with one or more particular user profiles 138-j.

The entertainment content personalization application 170 may generally provide features to present personalized content 180-g on a user interface 124 based on content data 136-i associated with the content 132-e and user data 134-f associated with users accessing the content 132-e. In one embodiment, a client 120-b may access the entertainment content personalization application 170 operating on a server 110-a, and any content 132-e associated therewith, utilizing a web browser application executing on the client 120-b including without limitation Microsoft® Internet Explorer®, Mozilla® Firefox®, Apple® Safari®, and Google Chrome™ browser applications. In another embodiment, a client 120-b may access the entertainment content personalization application 170 operating on a server 110-a utilizing a thin-client application and any associated thin-client hardware accessible by the client 120-b, including, but not limited to, ultra-thin client, web thin client, and mobile thin client implementations.

According to embodiments, components of the entertainment content personalization system 100 may access one or more third party services 190-h. Non-limiting examples of third party services 190-h include Facebook®, Twitter®, Pinterest®, YouTube®, and any other third party content or information service. In one embodiment, users may register with the entertainment content personalization system 100 utilizing an account affiliated with a third party service 190-h. In another embodiment, users registered with the entertainment content personalization system 100 may include third party service 190-h information as part of their user profile 138-j information. For example, user data 134-f for a particular user may include information regarding third party services 190-h associated with the user. In this manner, information and events associated with the third party services 190-h may be included in the user data 134-f.

In various embodiments, the entertainment content personalization application 140 may passively or actively receive information from one or more third party services 190-h of a user to generate a vector of user expressed intention. An example of passive receipt of information may be through automated push solutions of information from third party services 190-h, such as through monitoring of one or more really simply syndication (RSS) feeds. RSS feeds are simple text files that allow updates to content via standardized formats. An example of active receipt of information may be through automated push solutions. Some social networking sites may allow content providers to retrieve use and user data to determine trending information about how many social networking users are accessing its multimedia content, what types of content users are accessing and when they are accessing this content. This data retrieval is usually provided for by social networking sites through the use of an application programming interface (API) which allows content providers to access the various systems to download use data.

In various embodiments, the entertainment content personalization application 140 may perform data mining on the passively or actively received information from one or more third party services 190-h of a user to generate a vector of user expressed intention. For instance, the entertainment content personalization application 140 may receive a social graph of uniform resource locators (URLs) for websites and associated user identifiers. The entertainment content personalization application 140 may retrieve various webpages from websites corresponding to the URLs, and determine whether there is any matching websites for content 132-e. This may be accomplished using matching rules based on keywords, topical information, images, tags, and other multimedia information stored by webpages. For instance, a user may have a Facebook® account and may form a connection with an account associated with certain content 132-e, such as a Facebook® page dedicated to a particular television show. In another example, a user may have a Twitter® account and may post content related to certain content 132-e or may be a “follower” of one or more accounts related to content 132-e. This information, as well as information pertaining to certain information events, may be received by the entertainment content personalization system 100 and included in the user data 134-f. In one embodiment, information events may include events occurring through third party services 190-h. Non-limiting examples include Facebook® “likes,” by the user or by Facebook® “friends” of the user. Embodiments provide that the third party services 190-h may be accessible by the server 110-a, server 130-c, and the client 120-b.

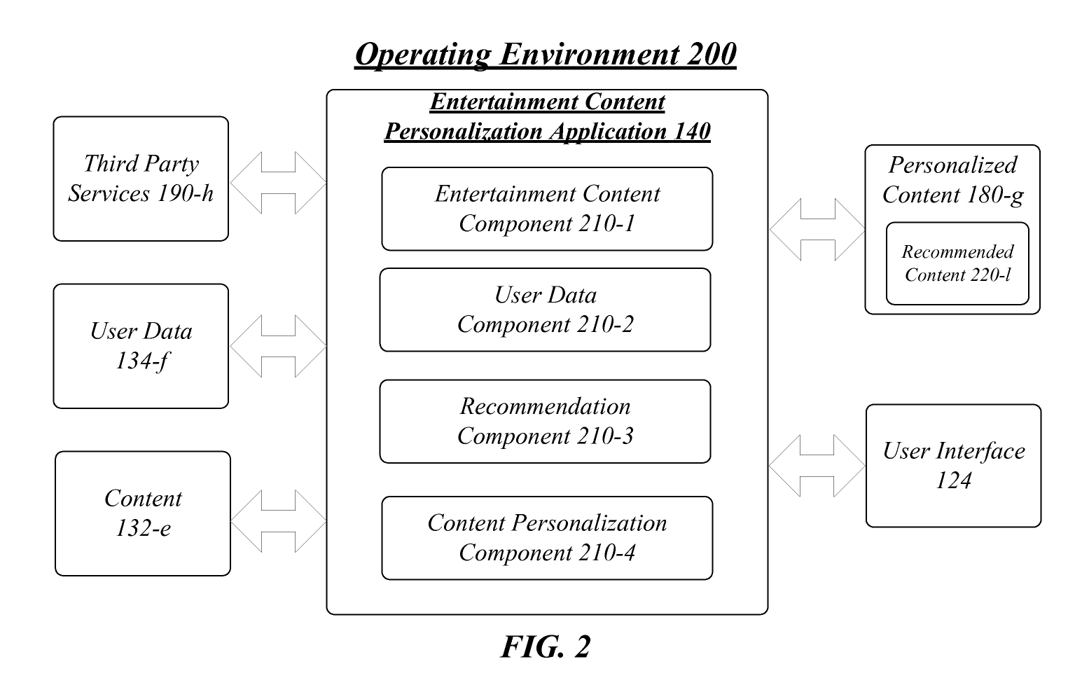

Particular aspects, embodiments and alternatives of the entertainment content personalization system 100 and the entertainment content personalization application 170 may be further described with reference to FIG. 2.

FIG. 2 illustrates an embodiment of an operating environment 200 for the entertainment content personalization system 100. More particularly, the operating environment 200 may illustrate a more detailed block diagram for the entertainment content personalization application 170.

As shown in FIG. 2, the entertainment content personalization application 170 may comprise various components 210-k. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the entertainment content personalization application 170 may comprise an entertainment content component 210-1, a user data component 210-2, a recommendation component 210-3, and a content personalization component 210-4. Although the entertainment content personalization application 170 shown in FIG. 2 has only four components in a certain topology, it may be appreciated that the entertainment content personalization application 170 may include more or less components in alternate topologies as desired for a given implementation. The embodiments are not limited in this context.

The entertainment content component 210-1 may generally operate to manage content 132-e for the entertainment content personalization system 100. Content 132-e may include original content and secondary content associated with or derived from the original content. For example, original content may comprise a television program initially provided over a television broadcast system. Secondary content may include, without limitation, games, contests, video clips, full episodes, season recaps, and discussion forums related to the original television program. The entertainment content component 210-1 may provide access to content 132-e to the server 110-a and the entertainment content personalization application 170 operating thereon. The client 120-b may access the content 132-e from server 110-a, which may be configured as a web server. The entertainment content component 210-1 may associate the content 132e with content data 136-i. Illustrative and non-restrictive examples of content data 136-i include names, dates, characters, actors, genres, categories, popularity rankings, quality ratings, descriptions, keywords, and other information associated with the content 132-e. A client 120-b may access a user interface 124 presented on a display 122. The user interface 124, for example, a website, may present the content 132-e to the user.

The user data component 210-2 may generally operate to manage user data 134-f associated with entertainment content personalization system 100 users. For example, users may register with the entertainment content personalization system 100 and may create a user profile 138-j comprising user data 134-f. Non-limiting examples of user data 134-f include name, location and demographic information, accessed content 132-e, preferences, data associated with third party services 190-h, entertainment content personalization system 100 interaction information, keyword searches, and combinations thereof. Accessed content 132-e information may include, without limitation, original and secondary content accessed by a user. The user data component 210-2 may obtain and maintain user data 134-f and user profiles 138-j contained within the user data 134-f.

The recommendation component 210-3 may generally operate to generate recommended content 220-l for a particular user accessing content 132-e from a client 120-b, such as through a user interface 124 presented via a display 122 accessible by the client 120-b. For example, the recommendation component 210-3 may recommend content 220-l to a user based on, inter alia, the content 132-e, content data 136-i, user data 134-f, or some combination thereof. In one embodiment, if a user accesses original content 132-e, such as a full episode of a television program, the recommendation component may recommend secondary content 132-e related to the original content 132-e. For instance, a game or forum directed toward the television program. In another embodiment, the recommendation component 210-3 may recommend content 132-e relevant to content 132-e viewed by a user. For example, user data 138-j may indicate that a particular user has accessed content 132-e related to a movie having content data 136-i placing the movie in a specific category (e.g., science fiction). The recommendation component 210-3 may generate recommended content 220-l of other movies also having content data 136-i placing them in the same category. According to certain embodiments, the recommendation component 210-3 may generate recommendations based on any type of content data 136-i, user data 134-f, or a combination thereof. For example, the recommendation component 210-3 may utilize keyword searches, fuzzy matches, and other various data analysis and matching to generate recommended content 220-l.

The content personalization component 210-4 may generally operate to present personalized content 180-g, for example, via a user interface 124 provided on a display 122 coupled to a client 120-b. The content personalization component 210-4 may access the user data 134-f associated with a registered user visiting the user interface 124, including any user profile 138-j data. For example, the user data 134-f may include previously viewed content 132-e or keyword searches performed by a particular user. The content personalization component 210-4 may present personalized content 180-g associated with the previously viewed content 132-e, such as content 132-e viewed a threshold number of times or content 132-e viewed within a threshold amount of time. In one embodiment, the content personalization component 210-4 may compare the user data 134-f associated with a registered user with the content data 136-i associated with the content 132-e to match user interests. For example, a user may be associated with user data 134-f indicating that the user is interested in reality television programming. As such, the content personalization component 210-4 may locate content 132-e having content data 136-i indicating that the content 132-e is affiliated with reality television programming and may present this content on the user interface 124 accessed by the user. The content personalization component 210-4 may present such content 132-e as personalized content 180-g, for instance, in a specified area of the user interface 124. The content personalization component 210-4 may interact with the recommendation component 210-3 to present recommended content 220-l, for example, as a subset of the personalized content 180-g.

According to certain embodiments, the content personalization component 210-4 may access any third party services 190-h associated with a particular user. For example, the content personalization component 210-4 may “crawl” or use other known analytics methods to determine user activity with a third party service 190-h relevant to the content 132-e. For example, a user posting a message via Twitter® related to certain content 132-e (e.g., entertainment content 132-e associated with a searchable Twitter® hash tag) or a user “liking” certain content on a Facebook® page related to content 132-e. Embodiments are not limited in this context.

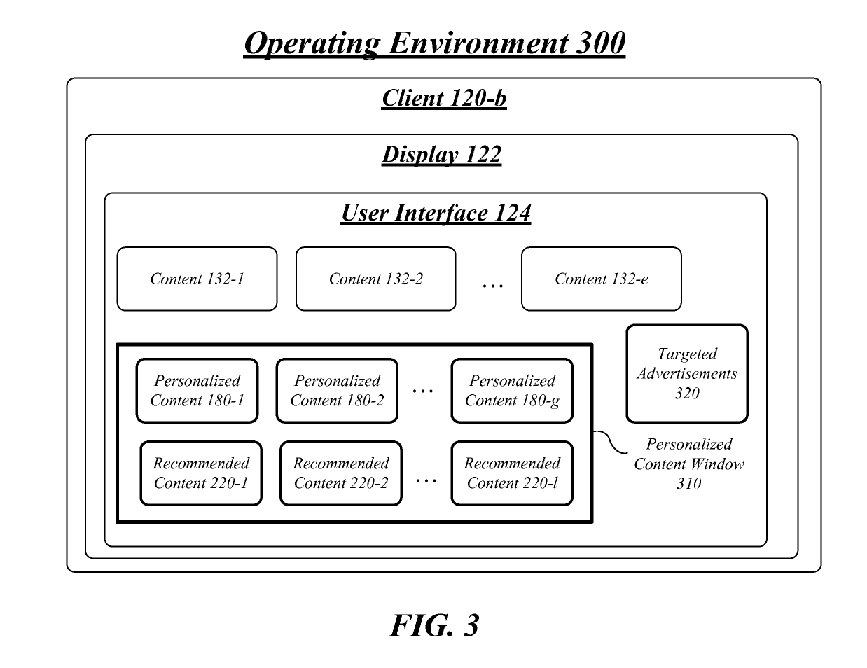

FIG. 3 illustrates an embodiment of an operating environment 300 for the entertainment content personalization system 100. More particularly, the operating environment 300 may illustrate a user interface 124 comprising personalized content 180-g provided according to embodiments described herein.

In the illustrated embodiment shown in FIG. 3, the user interface 124 may be presented to a user via a display 122 coupled to a client 120-b. For example, the user interface 124 may comprise an application interface for an application associated with an entertainment content provider, such as a mobile app configured for a mobile computing device. In another example, the user interface 124 may comprise a website for an entertainment content provider, such as www dot cbs dot com for entertainment content provider CBS Corporation. Entertainment content 132-1, 132-2, 132-e may be presented on the user interface 124. For instance, the content 132-1, 132-2, 132-e may comprise various graphics, links, audio, video, games, contests, forums, and voting associated with entertainment services and programming, such as television programming or a video game. The content personalization component 210-4 may be associated with a personalized content window 310 for displaying personalized content 180-1, 180-2, 180-g for a particular user visiting the user interface 124. In one embodiment, recommended content 220-1, 220-2, 220-l may be presented within the personalized content window 310 provided on the user interface 124. Embodiments are not limited to displaying personalized content 180-g in a segmented area of the use interface, such as the personalized content window. For example, a separate web page or application window may be utilized for displaying personalized content 180-g, recommended content 220-l, or both.

The content personalization component 210-4 may present dynamic and personalized web content on a website, browser or thin-client application with primary and/or secondary content in the form of content 132-e, personalized content 180-h, recommended content 220-l, or some combination thereof, in a highly customized format tailored to various users based on the user data 134-f. This provides a significant advantage over providing static and generic web content designed for a particular demographic. As previously described, an example of primary content may comprise original entertainment content, such as a reality television show. An example of secondary content may comprise companion content associated or related to the original entertainment content, such as games, blogs, chats, trailers, past episode of the original entertainment content, recommended content related to the original entertainment content, and so forth. The primary and/or secondary content may be viewed with both temporal and spatial limitations, as described below.

In one embodiment, primary and secondary content may be viewed, consumed or presented simultaneously on a same device, such as a first client 102-1. This use scenario is illustrated in the user interface 124 shown in FIG. 3. The first client 102-1 may comprise, for example, a fixed or mobile device such as a smart phone, tablet computer, notebook computer, desktop computer, and so forth. This may be appropriate where the first client 102-1 is attached to unified content delivery mechanisms, such as packet-switched networks (e.g., the Internet).

In one embodiment, primary and secondary content may be viewed, consumed or presented at a same time on different devices. For instance, a user may view content 132-e in the form of original entertainment content (e.g., a reality television show) on a second client 120-2, and simultaneously view content 132-e in the form of companion content for the original entertainment content (e.g., character profiles for the reality television show) on a third client 120-3. The second client 120-2 may comprise, for example, a home entertainment system such as a digital television. The third client 120-3 may comprise, for example, a fixed or mobile device such as a smart phone, tablet computer, notebook computer, desktop computer, and so forth. This may be appropriate where separate content delivery mechanisms are used for the clients 120-2, 120-3, such as a cable network for the original entertainment content and the Internet for the companion content.

In one embodiment, primary and secondary content may be viewed, consumed or presented at different times on a same device. For instance, a user may view content 132-e in the form of original entertainment content (e.g., a reality television show) on a fourth client 120-4 at a first time instant, and then view content 132-e in the form of companion content for the original entertainment content (e.g., character profiles for the reality television show) on the fourth client 120-4 at a second time instant. Time displacement may be of any granularity. This may be appropriate where the fourth client 102-4 is attached to unified content delivery mechanisms, such as packet-switched networks (e.g., the Internet), and a user desires to consume primary and secondary content in sequence rather than parallel, such as watching a television show and then accessing character profiles after the television show has completed.

In one embodiment, primary and secondary content may be viewed at different times on different devices. For instance, a user may view content 132-e in the form of original entertainment content (e.g., a reality television show) on a fifth client 120-5 at a first time instant, and then view content 132-e in the form of companion content for the original entertainment content (e.g., character profiles for the reality television show) on a sixth client 120-6 at a second time instant. Examples for the clients 120-5, 120-6 may be similar to those given for the clients 120-2, 120-3. This may be appropriate where separate content delivery mechanisms are used for the clients 120-2, 120-3, such as a cable network for the original entertainment content and the Internet for the companion content, and a user desires to consume primary and secondary content in sequence rather than parallel, such as watching a television show and then accessing character profiles after the television show has completed.

In addition to, or alternative from, providing dynamic and personalized web content in the form of content 132-e, personalized content 180-h, recommended content 220-l, or some combination thereof, based on user data 134-f, the content personalization component 210-4 may also present targeted advertisements 320 based on the user data 134-f. Various embodiments may provide additional content on the user interface 124 (e.g., a web page) where the additional content is targeted according to a user's online statements and behavior. The content personalization component 210-4 may perform data mining on the user data 134-f, and select one or more advertisements targeted to a particular user, or a demographic of the user. The targeted advertisements 320 may be stored in a database of the server 110-a, the client 120-b, or the server 130-c, or some other network storage device such as a dedicated advertising server. In one embodiment, the content personalization component 210-4 may serve targeted advertisements 320 based on one or both primary and secondary content used to generate the user interface 124.

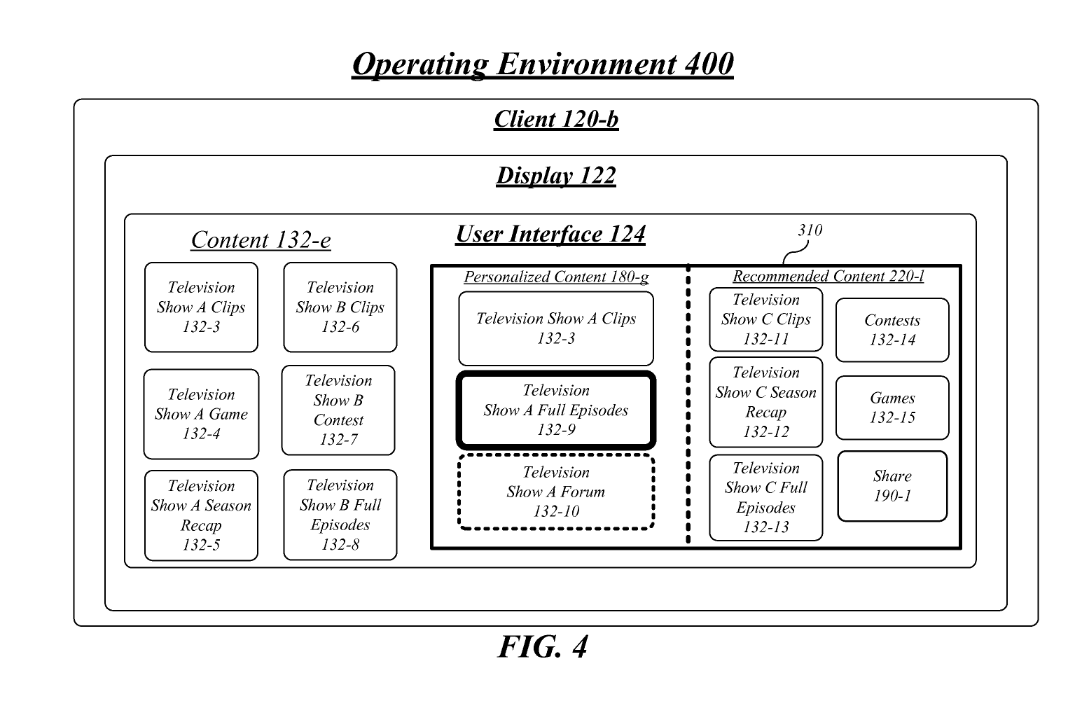

FIG. 4 illustrates an embodiment of an operating environment 400 for the entertainment content personalization system 100. More particularly, the operating environment 400 may illustrate a more detailed example of personalized content 180-g presentation on a user interface 124.

FIG. 4 illustrates a second case where the content personalization component 210-4 presents personalized content 180-g on a user interface 124 provided through a display 122 coupled to a client 120-b. The user interface 124 presents various content 132-e elements, including, without limitation, “Television Show A Clips” 132-3, “Television Show A Game” 132-4, “Television Show A Season Recap” 132-5, “Television Show B Clips” 132-6, “Television Show B Full Episodes” 132-7, and “Television Show B Contest” 132-8. A personalized content window 310 may be provided on the user interface 124 as a presentation area for personalized content 180-g and recommended content 220-l for a registered user interacting with the user interface 124.

As shown in FIG. 4, the personalized content 180-g may comprise “Television Show A Clips” 132-3, “Television Show A Full Episodes” 132-9, and “Television Show A Forum” 132-10. The personalized content 180-g may be selected based on the content data 136-i and the user data 134-f, including a user profile 138-j associated with a user accessing the user interface 124. For example, the user data 134-f may indicate that a user is interested in Television Show A based on data showing that the user has previously selected content associated with Television Show A, such as “Television Show A Clips” 132-3. According to certain embodiments, previously selected content 132-e may be presented as personalized content 180-g because, inter alia, a user may be likely interested in that content 132-e again. As such, “Television Show A Clips” 132-3 may be presented as personalized content 132-e, as shown in FIG. 3. The personalized content module 210-4 may locate personalized content 180-g based on the user data 134-f. For instance, the user data 134-f may indicate that the user may be interested in discussion forums or full episodes based on a selection made in the user profile 138-j. As such, the personalized content module 210-4 may present “Television Show A Full Episodes” 132-9 and “Television Show A Forum” 132-10 based on user profile 138-j data in combination with past browsing patterns.

In one embodiment, the entertainment content personalization system 100 may present the user with content alerts, for example, to inform the user that new content or unviewed content is available. As shown in FIG. 4, “Television Show A Full Episodes” 132-9 has been highlighted (bold) as a content alert, for instance, to alert the user that there is unviewed content 132-e. In another example, “Television Show A Forum” 132-10 has been highlighted (dotted line) to inform the user that there are new forum postings added since the user last visited “Television Show A Forum” 132-10. Content alerts are not limited to those depicted in FIG. 4, as the entertainment content personalization system 100 may utilize various other forms of alerting users, for instance, such as sending messages (e.g., e-mail messages) to users. Embodiments are not limited in this context.

The recommendation component 210-3 may operate to provide recommended content 220-l for display on the user interface 124. For example, the recommendation component 210-3 may analyze user data 134-f and content data 136-I to generate recommended content 220-l. User data for a particular user, for instance, may indicate that the user is interested in certain content 132-e available through the user interface 124, such as Television Show A. The user data 134-f for all user interface 124 users may indicate that users interested in Television Show A are likely to also be interested in Television Show C. For example, the user data 134-f may demonstrate that users who access Television Show A content 132-e have a high probability of also accessing Television Show C content 132-e, or the recommendation component 210-3 may recognize that the television shows may involve related subject matter, genres, or other characteristics wherein users are likely to have a shared interest. As such, the recommendation component 210-3 may generate recommended content 220-l such as “Television Show C Clips”132-3, “Television Show C Season Recap” 132-3, and “Television Show C Full Episodes” 132-8. Thus, embodiments may present a user with recommended content 220-l that they may have not accessed otherwise.

In addition to recommending content 132-e associated with specific content offerings, the recommendation component 210-3 may recommend certain categories of content, such as contests 132-14, games 132-15, and third party services, such as a share 190-1 service where users may share information, such as comments, discussions, and links, involving content 132-e available through the user interface 124. For example, if the user data 1341, including the user profile 138-j, for a particular user indicates that the user is interested in certain content 132-e, the recommendation component 210-3 may recommend a contest 132-14 related to that content 132-e. In one embodiment, the contest 132-14 may involve the user registering as a “fan” or “super fan” of the content 132-e, such as a television program or movie, and competing against other fans or super fans of the content 132-e. As the user interacts with the user interface 124 and the content 132-e presented through the user interface 124, user data 134-f associated with the user may be modified by the user data component 210-2. In this manner, the personalized content 180-g and the recommended content 220-l presented to users through the user interface 124 may be dynamically and automatically updated to represent user interests.

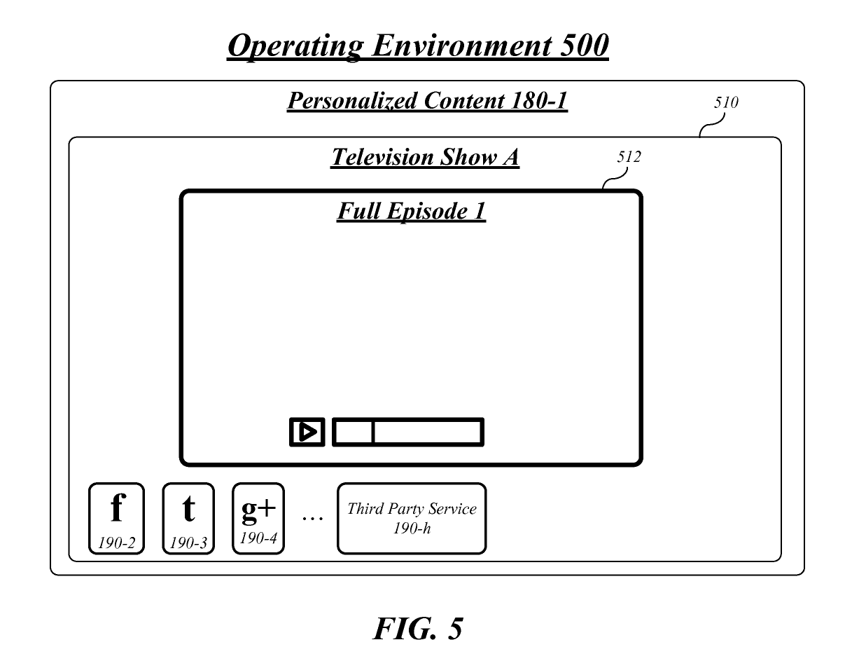

FIG. 5 illustrates an embodiment of an operating environment 500 for the entertainment content personalization system 100. More particularly, the operating environment 500 may illustrate a more detailed example of personalized content 180-g presentation on a user interface 124.

In FIG. 5, personalized content 180-1 is presented to a user in the form of a full episode 512 video of Television Show A 510. One or more third party services 190-h may be associated with content 132-e within the entertainment content personalization system 100. For example, Television Show A 510 and/or full episode 512 may be associated with one or more third party services 190-h, including, without limitation, Facebook® 190-2, Twitter® 190-3, and Google+190-4. The third party services 190-2, 190-3, 190-4, 190-h may be presented to users as one or more widgets on the user interface 124. Selection of one or more of the widgets may launch the selected third party service 190-h, for example, by opening the third party service 190-h website. In one embodiment, selection of a third party service 190-h may open the third party service 190-h in a manner that presents information related to the personalized content 510, 512, 180-1, 180-g, the user, the entertainment content personalization system 100, content 132-e, or some combination thereof.

According to certain embodiments, user interfaces associated with the third party services 190-h (e.g., a third party service website) may host a widget associated with the entertainment content personalization system 100 and content 132-e associated therewith. In this manner, a user interacting with the third party service 190-h may select the entertainment content personalization system 100 widget and access the user interface 124. For example, a Twitter® user may access content on Twitter® related to certain entertainment content personalization system 100 content 132-e, such as a post involving Television Show A. The user may select an entertainment content personalization system 100 widget located within Twitter® to access a user interface 124 associated with Television Show A. Embodiments are not limited in this context.

In addition to, or alternative from, the content personalization component 210-4 presenting dynamic and highly personalized web content in the form of content 132-e, personalized content 180-h, and/or recommended content 220-l for a user based on the user data 134-f, embodiments may implement techniques to “gamify” the user interface 124. Various embodiments may implement a game navigation interface specifically designed to influence user behavior when navigating electronic content (e.g., a website) through gaming techniques. Games and related gaming techniques (e.g., missions, awards, and points) may be implemented to engage a user and encourage exploration and interaction with electronic content by becoming actively involved in a game specifically designed around, and integrated with, a particular set of electronic content. While a primary purpose for a game is entertainment, the game navigation interface is designed to use the entertainment aspect of gaming to shape user behavior in an incremental fashion when navigating electronic content provided by a content delivery platform. As such, the game navigation interface turns a game into a “metagame” that is used primarily as a marketing tool for different types of content provided by a content delivery platform. In this manner, a content provider may provide a superior user experience while enhancing monetization of a content delivery platform, among other advantages.

Embodiments may implement various enhanced navigation techniques for the user interface 124 that are arranged to allow a user to navigate to a specific set of electronic content presented by a network. For instance, embodiments may comprise a game navigation interface arranged to implement various types of games, strategies, missions, tasks and other gaming techniques traditionally found in gaming applications to assist in navigating hosted multimedia content, such as provided by an application program, a system program, a web site, a web page, a web part, a web application, a web service, and so forth. The games may have one or more game objectives that when achieved leads a user to specific target content for a content delivery platform, such as specific portions of a web page or a web site shown by the user interface 124, for example. In this manner, a game designer may design a game in a way that leads users to higher value portions of a web site, such as advertisements, marketing events, web site features (e.g., registration), and so forth. Further, a game navigation interface may cause a user to stay on a content delivery platform for a longer time period, thereby increasing “stickiness.” In addition, a game navigation interface may allow a content provider to track user activity and gauge user interest or intent through game status, scoring, awards, emblems, social media comments, and so forth.

In one embodiment, a computer-implement system may comprise a game navigation application operative to manage a game for a content delivery platform which provides the user interface 124. The game navigation application may comprise, among other elements, a monitoring component operative to monitor navigation commands for navigating multimedia content provided by the content delivery platform, and output a game trigger signal based on the navigation commands. The game navigation application may further comprise a game navigation component operative to receive the game trigger signal, and select a game arranged to assist a user in navigating the multimedia content in response to the game trigger signal. The game may have a game objective designed to lead a user from current multimedia content to target multimedia content of the content delivery platform. The target multimedia content may comprise a higher value multimedia content relative to the current multimedia content, as measured by some form of value measurements (e.g., advertising revenue). A representative example of a game navigation application suitable for use with embodiments may be described in commonly owned and previously filed U.S. patent application Ser. No. 13/180,879 entitled “Game Navigation Interface For Electronic Content” filed on Jul. 12, 2011, the subject matter of which is hereby incorporated by reference in its entirety.

With respect to the entertainment content personalization application 170, the game navigation application may gamify the user interface 124 to allow a user more easily navigate the customized content provided by the user interface 124. For instance, a user may play a game to accumulate sufficient gaming points to unlock content 132-e, such as a new episode of a television series. A user might accumulate gaming points by watching X number or type of videos, providing comments on cast member biographies, sending information about content 132-e to friends or followers of social networking sites, visiting specified portions of the user interface 124, completing a user profile or survey, and other defined task. Tasks, point allocations and rewards may vary according to a given implementation, and the embodiments are not limited in this context.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

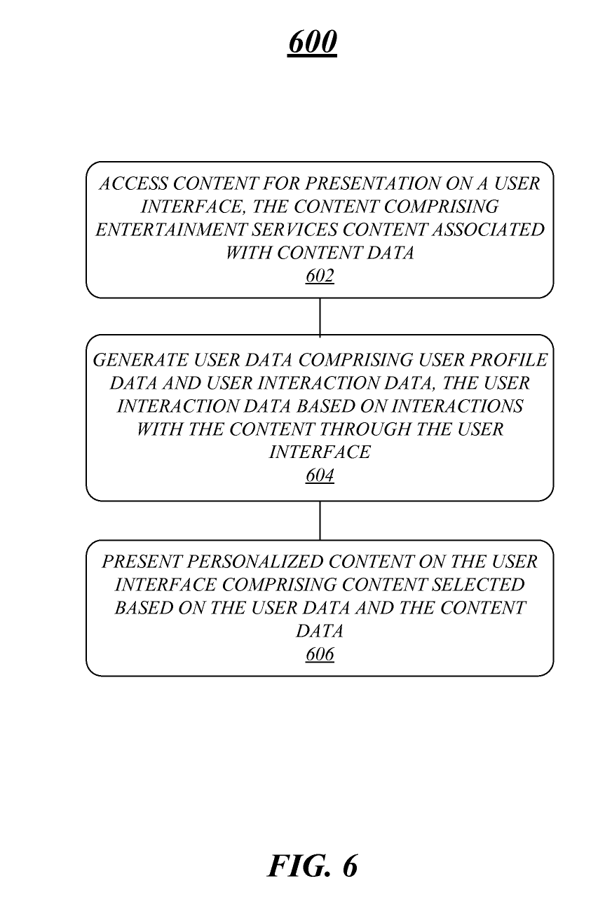

FIG. 6 illustrates one embodiment of a logic flow 600. The logic flow 600 may be representative of some or all of the operations executed by one or more embodiments described herein. For example, the logic flow 600 may illustrate operations performed by the entertainment content personalization system 100.

In the illustrated embodiment shown in FIG. 6, the logic flow 600 may access content for presentation on a user interface, the content comprising entertainment services content associated with content data at block 602. For example, the entertainment content personalization application 170 operating on server 110-a may access content 132-e stored on server 130-c, such as through the entertainment content component 210-1. The content 132-e may be comprised of entertainment services content associated with one or more entertainment content providers, including, without limitation, television, movies, music, video games, books, and online content. According to embodiments, the content 132-e may be associated with content data 136-i configured to provide information about the content 132-e. Exemplary forms of content data 136-i include names, titles, characters, genres, categories, age appropriateness, rankings, ratings, and keywords.

The logic flow 600 may generate user data comprising user profile data and user interaction data, the user interaction data based on interactions with the content through the user interface at block 604. For example, a user may register with the entertainment content personalization system 100, creating a user profile 138-j. The user profile 138-j may contain user data 134-f, such as demographic information and user interest information. Embodiments provide for generating user data 134-f based on user interaction with the content 132-e. For instance, the user data 134-f may include, without limitation, previously viewed content, types of viewed content (e.g., games, forums, videos), and any other type of data tending to demonstrate user interest in content 132-e. The user data component 210-2 may operate to manage the generation and retrieval of user data 134-f, including user profiles 138-j.

The logic flow 600 may present personalized content on the user interface comprising content selected based on the user data and the content data at block 606. For example, the content personalization component 210-4 may analyze the user data 134-f for a particular user and the content information 136-i to select content 132-e as personalized content 180-g for presentation on the user interface 124. In one example, the user data 134-f for a particular user may provide that the user has accessed content for Television Show A, such as videos for Television Show A, and has played games through the user interface 124. The content personalization component 210-4 may analyze the user data 134-f and select Television Show A video content and games related to Television Show A as personalized content 180-g for the particular user.

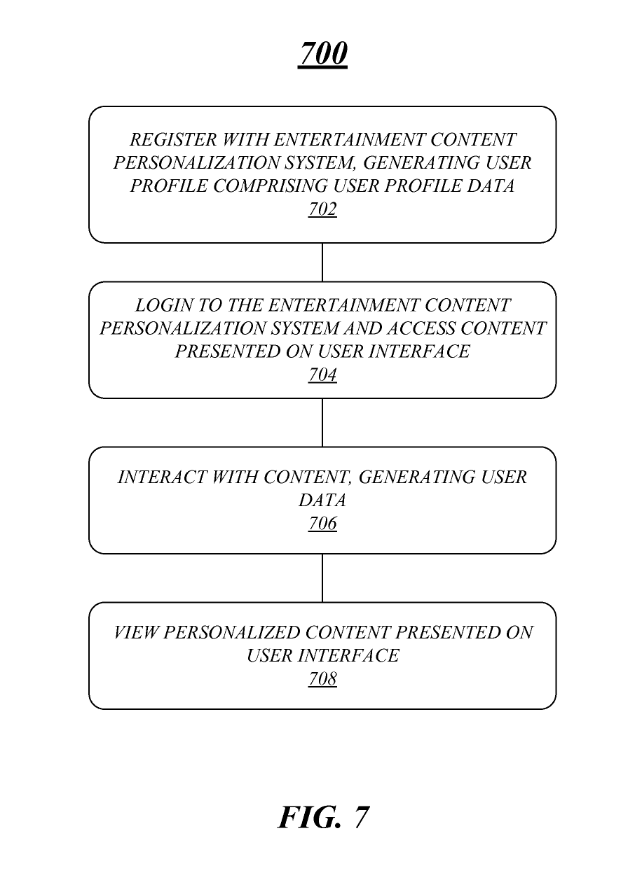

FIG. 7 illustrates one embodiment of a logic flow 700. The logic flow 700 may be representative of some or all of the operations executed by one or more embodiments described herein. For example, the logic flow 700 may illustrate operations performed by the entertainment content personalization system 100.

The logic flow 700 may register with entertainment content personalization system, generating user profile comprising user profile data at block 702. For example, a user may register with the entertainment content personalization system 100. Registered users may be associated with a user profile 138-j containing profile information, such as demographic and location information, content preferences, or content rankings.

The logic flow 700 may login to the entertainment content personalization system and access content presented on user interface at block 704. For example, a registered user may login to the entertainment content personalization system 100 utilizing credentials provided in their user profile 138-j. The user may access content 132-e presented on the user interface 124, such as a website associated with a content provider. A registered user logged into the entertainment content personalization system 100 may be associated with user data 134-f related to accessed content 132-e.

The logic flow 700 may interact with content, generating user data at block 706. For example, a user may interact with content 132-e presented on the user interface 124, including watching videos, playing games, entering contests, and performing keyword searches. Interaction with content 132-e by a registered user may generate user data 134-f that may be associated with the user. The user data 134-f may indicate various access habits of the user, such as previously viewed content and user interface 124 browsing patterns. The user data 134-f may be generated by the content personalization application 170 operating on the server 110-a, for example, utilizing the user data component 220-2.

The logic flow 700 may view personalized content presented on user interface at block 708. For example, the user may access personalized content 180-g presented on the user interface. The personalized content 180-g may comprise content 132-e selected by the content personalization component 210-4 based on the user data 134-f associated with the user. In this manner, a user may receive an individualized experience each time they access the user interface 124, with content 132-e that they are likely to be interested in presented in an efficient, accessible format, such as a personalized content window 310 on the user interface 124.

FIG. 8 illustrates an embodiment of an exemplary computing architecture 800 suitable for implementing various embodiments as previously described. In one embodiment, the computing architecture 800 may comprise or be implemented as part of servers 110-a, servers 130-c, or clients 120-b.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, such as those described with reference to the processor circuit 140 shown in FIG. 1.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

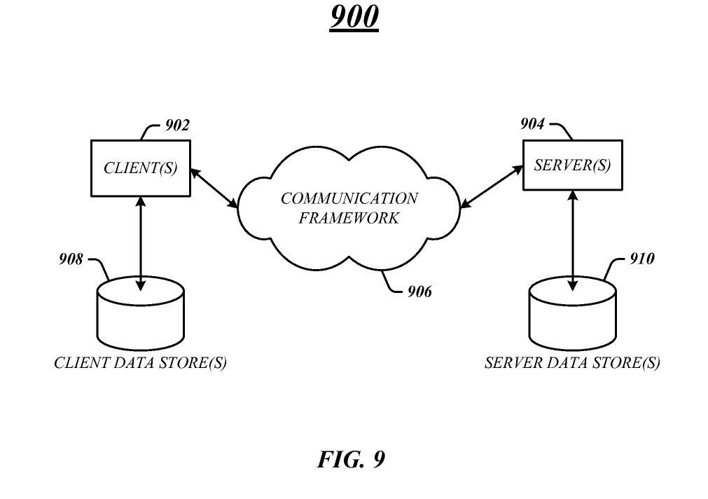

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the client device 150. The servers 904 may implement summary engine device 110, and publication site 140. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

The various elements of the entertainment content personalization system 100 as previously described with reference to FIGS. 1-9 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method comprising:
accessing content for presentation on a user interface, the content comprising entertainment services content associated with content data;
generating user data comprising user profile data and user interaction data, the user interaction data based on interactions with the content through the user interface; and
presenting personalized content on the user interface comprising content selected based on the user data and the content data.

2. The computer-implemented method of claim 1, the content data comprising information associated with the entertainment services content comprising at least one of: a genre, a subject, one or more keywords, a popularity ranking, and a quality rating.

3. The computer-implemented method of claim 1, the user data comprising at least one of: previously accessed content information, browsing patterns, preferences, ratings, and demographic information.

4. The computer-implemented method of claim 1, the user data comprising information obtained from one or more third party services, the one or more third party services comprising a social networking service.

5. The computer-implemented method of claim 1, the personalized content comprising previously accessed entertainment services content.

6. The computer implemented method of claim 5, the personalized content comprising entertainment services content associated with the previously accessed entertainment services content.

7. The computer-implemented method of claim 6, the personalized content comprising at least one of: a contest, a game, a video, a discussion forum.

8. The computer-implemented method of claim 6, the previously accessed entertainment services content comprising a television program video and the personalized content comprising a game associated with the television program.

9. The computer-implemented method of claim 1, further comprising generating recommended content for presentation on the user interface, the recommended content comprising entertainment services content related to previously accessed entertainment services content.

10. The computer-implemented method of claim 9, the previously accessed entertainment services content comprising a first television program video and the recommended content comprising a second television program video having content data related to the first television program.

11. An apparatus, comprising:
a transceiver;
a processor circuit coupled to the transceiver; and
a memory unit coupled to the processor circuit, the memory unit to store an entertainment content personalization application operative on the processor circuit to present personalized entertainment services content on a user interface, the entertainment content personalization application comprising:
an entertainment content component operative to access content for presentation on the user interface, the content comprising entertainment services content associated with content data;
a user data component operative to generate user data comprising user profile data and user interaction data, the user interaction data based on interactions with the content through the user interface; and
a personalized content component operative to present personalized content on the user interface comprising content selected based on the user data and the content data.

12. The apparatus of claim 11, the content data comprising information associated with the entertainment services content comprising at least one of: a genre, a subject, one or more keywords, a popularity ranking, and a quality rating.

13. The apparatus of claim 11, the user data comprising at least one of: previously accessed content information, browsing patterns, preferences, ratings, and demographic information.

14. The apparatus of claim 11, the user data comprising information obtained from one or more third party services, the one or more third party services comprising a social networking service.

15. The apparatus of claim 11, the personalized content comprising previously accessed entertainment services content.

16. The apparatus of claim 15, the personalized content comprising entertainment services content associated with the previously accessed entertainment services content.

17. The apparatus of claim 16, the personalized content comprising at least one of: a contest, a game, a video, a discussion forum.

18. The apparatus of claim 16, the previously accessed entertainment services content comprising a television program video and the personalized content comprising a game associated with the television program.

19. The apparatus of claim 11, further comprising a recommendation component operative to generate recommended content for presentation on the user interface, the recommended content comprising entertainment services content related to previously accessed entertainment services content.

20. The apparatus of claim 19, the previously accessed entertainment services content comprising a first television program video and the recommended content comprising a second television program video having content data related to the first television program.

21. At least one computer-readable storage medium comprising instructions that, when executed, cause a system to:
access content for presentation on a user interface, the content comprising entertainment services content associated with content data;
generate user data comprising user profile data and user interaction data, the user interaction data based on interactions with the content through the user interface; and
present personalized content on the user interface comprising content selected based on the user data and the content data.

22. The computer-readable storage medium of claim 21, the content data comprising information associated with the entertainment services content comprising at least one of: a genre, a subject, one or more keywords, a popularity ranking, and a quality rating.

23. The computer-readable storage medium of claim 21, the user data comprising at least one of: previously accessed content information, browsing patterns, preferences, ratings, and demographic information.

24. The computer-readable storage medium of claim 21, the user data comprising information obtained from one or more third party services, the one or more third party services comprising a social networking service.

25. The computer-readable storage medium of claim 21, the personalized content comprising previously accessed entertainment services content.

26. The computer-readable storage medium of claim 25, the personalized content comprising entertainment services content associated with the previously accessed entertainment services content.

27. The computer-readable storage medium of claim 26, the personalized content comprising at least one of: a contest, a game, a video, a discussion forum.

28. The computer-readable storage medium of claim 26, the previously accessed entertainment services content comprising a television program video and the personalized content comprising a game associated with the television program.

29. The computer-readable storage medium of claim 21, comprising instructions that when executed cause the system to generate recommended content for presentation on the user interface, the recommended content comprising entertainment services content related to previously accessed entertainment services content.

30. The computer-readable storage medium of claim 29, the previously accessed entertainment services content comprising a first television program video and the recommended content comprising a second television program video having content data related to the first television program.

31. A computer-implemented method comprising:
interacting with entertainment services content presented on a user interface to generate user data, the entertainment services content associated with content data;
accessing personalized content on the user interface, the personalized content comprising content selected based on the user data and the content data.

32. The computer-implemented method of claim 31, the content data comprising information associated with the entertainment services content comprising at least one of:
a genre, a subject, one or more keywords, a popularity ranking, and a quality rating.

33. The computer-implemented method of claim 31, the user data comprising at least one of: previously accessed content, browsing patterns, preferences, ratings, and demographic information.

34. The computer-implemented method of claim 31, the user data comprising information obtained from one or more third party services, the one or more third party services comprising a social networking service.

36. The computer implemented method of claim 35, the personalized content comprising entertainment services content associated with previously accessed entertainment services content.

37. The computer-implemented method of claim 6, the personalized content comprising at least one of: a contest, a game, a video, a discussion forum.
